(19) United States
(12) Patent Application Publication
(10) Pub. No.: US 2009/0271532 A1
(43) Pub. Date: Oct. 29, 2009

(54) Early header CRC in data response packets with variable gap count

(76) Inventors: Brian D. Allison, Rochester, MN (US); Wayne M. Barrett, Rochester, MN (US); Mark L. Rudquist, Rochester, MN (US); Kenneth M. Valk, Rochester, MN (US); Brian T. Vanderpool, Byron, MN (US)

Correspondence Address: IBM Corporation;Intellectual Property Law Dept. 917, 3605 Hwy. 52 North, Rochester, MN, 55901, US

(21) Appl. No.: 12/108,744

(22) Filed: Apr. 24, 2008

(51) Int. Cl. G06F 13/14

(52) U.S. Cl. 710/7

(57) ABSTRACT

A method is provided for processing a command issued by a processor over a bus. The method includes (1) transmitting the command to a remote node to obtain access to data required to complete the command; (2) receiving from the remote node a response packet including a header and a header CRC; (3) validating the response packet including the header and the header CRC; (4) loading a timer to run until data required to complete the command is received or the timer expires; and (5) before receiving the data required to complete the command, arranging to return the data to the processor over the bus.

### CROSS REFERENCE TO RELATED APPLICATION

The present application is related to U.S. patent application Ser. No. ______, filed ______ and titled “EARLY HEADER CRC IN DATA RESPONSE PACKETS WITH VARIABLE GAP COUNT” (Attorney Docket No. ROC920070045US1), and to U.S. patent application Ser. No. ______, filed ______ and titled “EARLY HEADER CRC IN DATA RESPONSE PACKETS WITH VARIABLE GAP COUNT” (Attorney Docket No. ROC920070353US1), both of which are hereby incorporated by reference herein in their entirety.

### FIELD OF THE INVENTION

The present invention relates generally to processors, and more particularly to methods and apparatus for processing a command.

### BACKGROUND OF THE INVENTION

A processor may transmit commands (e.g., read and write requests) to and receive response data from a memory controller over a bus. As different requests sent by the processor to the memory controller may take different amounts of time to execute, response data may often be returned to the bus out-of-order with respect to the sequential order of requests. Thus, in some instances, a response to a request may be deferred as the memory controller attempts to retrieve the data associated with the request, which may introduce a certain amount of latency time. Due to such latency, phases of communication between the processor and the memory controller over the bus may be stalled, slowed or otherwise delayed. Consequently, methods and apparatus for reducing such latency time and thereby increasing processing efficiency would be desirable.

### SUMMARY OF THE INVENTION

In a first aspect of the invention, a first method is provided for processing a command issued by a processor over a bus. The first method includes (1) transmitting the command to a remote node to obtain access to data required to complete the command; (2) receiving from the remote node a response packet including a header and a header CRC; (3) validating the response packet including the header and the header CRC; (4) loading a timer to run until data required to complete the command is received or the timer expires; and (5) before receiving the data required to complete the command, arranging to return the data to the processor over the bus.

In a second aspect of the invention, a second method is provided for processing a command issued by a processor. The second method includes (1) receiving the command from a requesting node over a communication link; (2) incorporating a header and a header CRC in a response packet; (3) transmitting the response packet including the header and header CRC before all of the data required to complete the command has been obtained; (4) determining than an error in the data required to complete the command has occurred; and (5) reobtaining the data required to complete the command.

In a third aspect of the invention, a first apparatus is provided which includes (1) at least one processor; (2) a memory controller coupled to and adapted to receive commands from one of the at least one processor via a bus, and coupled to one or more remote nodes via a communication link. The memory controller is adapted to transmit a command issued by the at least one processor to a remote node over the communication link to obtain access to data required to complete the command; receive from the remote node a response packet including a header and a header CRC; validate the response packet including the header and the header CRC; load a timer to run until data required to complete the command is received or the timer expires; and before receiving the data required to complete the command, arrange to return the data to the processor over the bus.

In a fourth aspect of the invention, a second apparatus is provided which includes (1) an interface adapted to receive a command from one or more requesting nodes over a communication link; (2) memory including data required to complete the command; and (3) a memory controller coupled to the interface, the memory controller being adapted to construct a response packet including a header and a header CRC. The memory controller is adapted to transmit the response packet including the header and header CRC before all of the data required to complete the command has been obtained; determine than an error in the data required to complete the command has occurred; and reobtain the data required to complete the command.

Other features and aspects of the present invention will become more fully apparent from the following detailed description, the appended claims and the accompanying drawings.

### BRIEF DESCRIPTION OF THE FIGURES

FIG. 1 is a block diagram of an exemplary apparatus for processing commands in accordance with an embodiment of the present invention.

FIG. 2 is a block diagram of a system including a plurality of apparatuses for processing commands in accordance with an embodiment of the present invention.

FIG. 3 is an exemplary timing diagram of a method of processing of a command at a requesting node in accordance with an embodiment of the present invention.

FIG. 4A illustrates an exemplary response packet including a header CRC in accordance with an embodiment of the present invention.

FIG. 4B illustrates an exemplary double-wide response packet including a header CRC in accordance with an embodiment of the present invention.

FIG. 4C illustrates an exemplary response packet including gap cycles in accordance with an embodiment of the present invention.

FIG. 5A is an exemplary timing diagram of a method of processing of a command at a requesting node including error recovery in accordance with an embodiment of the present invention.

FIG. 5B is an exemplary timing diagram of another method of processing of a command at a requesting node including error recovery in accordance with an embodiment of the present invention.

### DETAILED DESCRIPTION

An embodiment of the present invention may provide methods and apparatus for processing a command. A computer system may include one or more processors that may initiate commands, including read and write requests. The data required to fulfill a request may be found in local memory (e.g., dynamic access memory (DRAM)) resources or alternatively, may be found in memory located on a remote computer system (‘remote node’) which may be coupled to the initiating processor (e.g., over a network). Compared with local access, remote data access typically takes more time, introducing a latency period between the issuance of a request from the requesting node and the return of the data from the remote node.

According to the methods and apparatus of embodiments of the present invention, the latency period that may occur between a data request being sent from a requesting node and the return of the requested data from the remote node may be reduced by incorporating a cyclic redundancy check (CRC) check that covers a response packet header (‘header CRC’). Incorporation of the header CRC may allow validation of a data response header in advance of a full data transfer and a final CRC check over an entire data response packet, enabling an early initiation of a deferred reply before all of the remote data is returned by the remote node. In addition, methods and apparatus of embodiments of the present invention may provide for insertion of a variable data gap in a response by a remote node to further advance the early indication. Methods and apparatus of embodiments of the present invention also may provide a recovery mechanism that may provide for recovery in the event that the data contains one or more errors (i.e., the data CRC does not check out).

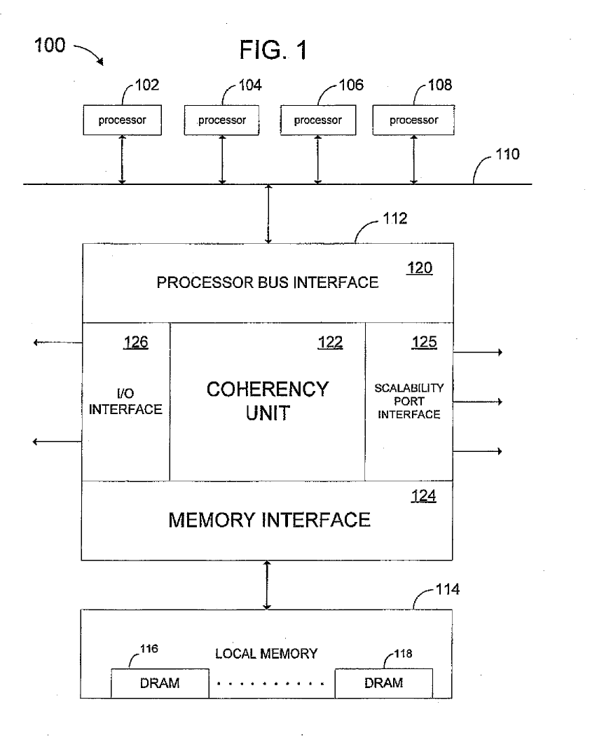

FIG. 1 is a block diagram of an exemplary apparatus for processing commands in accordance with an embodiment of the present invention. With reference to FIG. 1, the apparatus 100 may comprise a computer system or similar device. The apparatus 100 may include a plurality of processors 102, 104, 106, 108 that may each be coupled to a bus 110, such as a processor bus (e.g., an Intel point-to-point processor bus). The processors 102, 104, 106, 108 may comprise any type of general or special purpose processors, including, but not limited to microprocessors, digital signal processors, graphics processors, device controllers, etc. The bus 110 may provide a communication channel between the processors 102, 104, 106, 108 and other components of the apparatus 100 (including between each other). In the depicted embodiment, the apparatus includes four processors 102, 104, 106, 108 and one bus 110. However, a larger or smaller number of processors and busses may be employed.

Each of the plurality of processors 102, 104, 106, 108 may issue a command (or one or more portions of a command) onto the bus 110 for processing. To provide for the servicing of commands issued by the processors 102, 104, 106, 108 and access to memory resources, the apparatus 100 may include a memory controller (e.g., chipset) 112 which may be coupled to the bus 110. The apparatus 100 may further include local memory 114 coupled to the memory controller 112, which may include one or more memory units 116, 118 (e.g., DRAMs, cache, or the like).

A command (e.g., a read request) issued by a processor 102, 104, 106, 108 may include a header, command and address information. The address information included in the command may indicate a memory location where data requested to be read may reside. The memory controller 112 may be adapted to schedule and route commands received from the processors 102, 104, 106, 108 over the bus 110 to memory locations specified in the commands, which may be situated in either local memory 114 or in memory external to the apparatus 100.

The memory controller 112 may include several sub-components adapted to perform the tasks of processing commands and providing memory access. In one or more embodiments, the memory controller 112 may include a bus interface 120 which may be adapted to receive commands from the processors 102, 104, 106, 108 via the bus 110 and to regulate communication with the processors via a bus protocol, whereby commands received from the processors 102, 104, 106, 108 may be executed in various discrete transaction stages determined by the relevant bus protocol. Exemplary command transaction stages that may be employed in the context of an embodiment of the present invention are described further below.

A coherency unit 122 may be coupled to and receive command transactions from the bus interface 120. The coherency unit 122 may be adapted to (1) store pending commands (e.g., in a queue or similar storage area); (2) identify pending commands, which are accessing or need to access a memory address, that should complete before a new command that requires access to the same memory address may proceed; and/or (3) identify a new command received in the memory controller 112 as colliding with (e.g., requiring access to the same memory address as) a pending command previously received in the memory controller 112 that should complete before a second phase of processing is performed on the new command.

The coherency unit 122 may further be adapted to manage a lifetime of the transactions associated with the execution of a command. For example, if a read request issued by a processor 102, 104, 106, 108 is to be deferred for a period before the requested data is returned, the coherency unit 122 may perform tasks such as (i) providing an early indication that the request is being deferred while remote data is being accessed, (ii) checking whether data accessed contains errors, and (iii) indicating when data has been returned from the remote node.

The coherency unit 122 may further include a local memory interface 124, a scalability port interface 125 and an I/O interface 126 (e.g., within the memory controller 120). The local memory interface 124 may enable data communication between the coherency unit 122 and the local memory system 114, and in particular, enable the coherency unit to access data stored in the local memory system 114 within apparatus 100. The scalability port interface 125 may enable communication between the coherency unit 122 and one or more remote nodes coupled to the scalability port interface 125. The I/O interface 126 may enable communication between the coherency unit 122 and one or more peripheral devices (not shown).

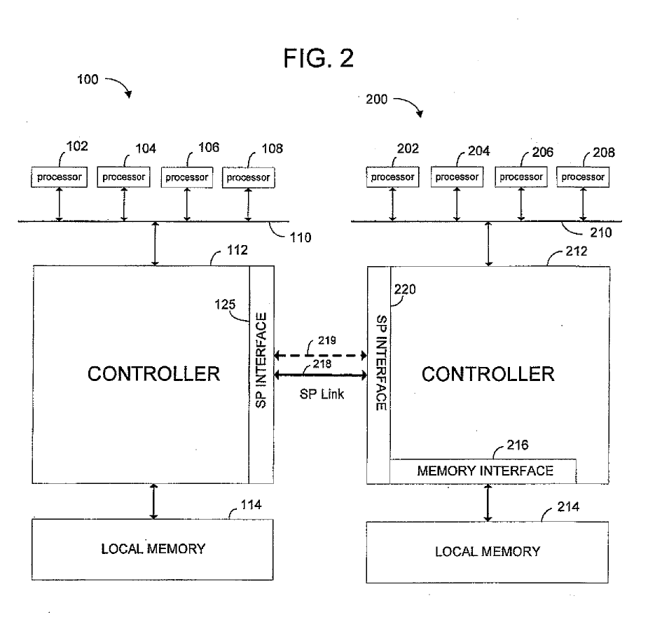

FIG. 2 is a block diagram showing the first apparatus 100 according to the invention coupled via scalability port 125 coupled to a remote node 200, which may comprise an apparatus having one or more processors 202, 204, 206, 208 coupled via a bus 210 to a memory controller 212, similar to apparatus 100. Apparatus 200 may further include a local memory 214 coupled to memory controller 212 via a memory interface 216. As shown, apparatus 100 may be coupled to apparatus 200 via an SP link 218, such as a high-capacity cable, and optionally by a second SP link 219 (shown in phantom) which couples a scalability port 125 to a corresponding scalability port 220 of apparatus 200. In one or more embodiments, data communication between the apparatuses 100, 200 over SP link 218 may be conducted at a high speed, for example, 5.2 gigabits per second (GB/s) at 2 bytes per cycle. In other embodiments, simultaneous use of SP links 218, 219 may provide a double-wide link with data transmission at a rate of 4 bytes per cycle.

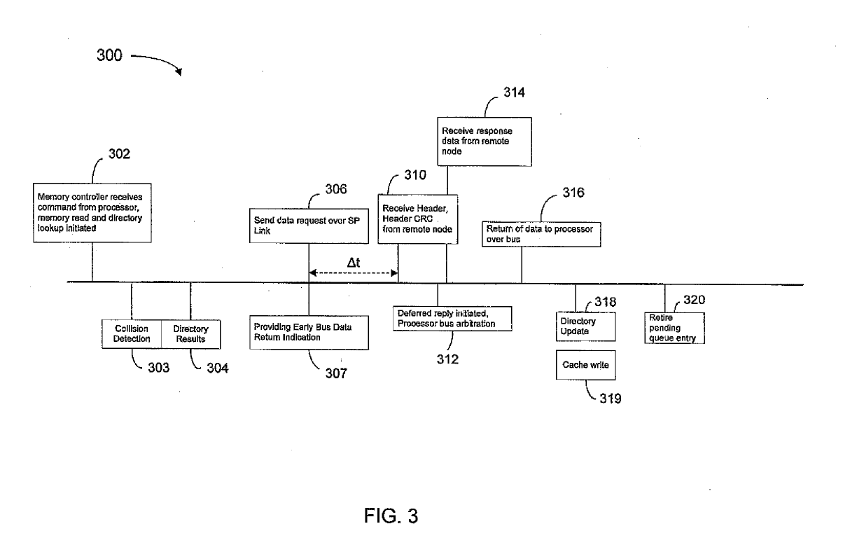

FIG. 3 is a timing diagram illustrating a sequence of transactions/events 300 that may be performed at a requesting node according to an exemplary method of processing of a command according to the present invention. For the sake of illustration, apparatus 100 may comprise a requesting node that requests access to data residing in the local memory 214 in apparatus 200 via a read request. It is noted, however, that this example is arbitrary and that the roles may be reversed, with apparatus 200 initiating a command and acting as the requesting node and apparatus 100 providing response data and acting as the remote node.

In a first stage 302 of command processing, referred to as request phase, a processor (e.g., 102) may issue a command on the bus 110 such that the command may be observed by components coupled to the bus 110, such as remaining processors 104, 106, 108 and/or the memory controller 112. For example, in stage 302, the coherency unit 122 may initiate a collision check to determine whether there is a conflict with other pending requests with respect to the address associated with the command. The coherency unit 122 may also initiate a directory lookup to determine whether the data requested may be found in local memory resources 114 or on one or more remote nodes 200, and then may log the new command in a pending request queue. In stages 303, 304, referred to collectively as a snoop phase, results or processes initiated in stage 302 may be presented. For example, in stage 303, any collisions between other pending requests may be determined, and in stage 304, directory results may be ascertained.

In a third phase (e.g., response phase) of command processing, the coherency unit 122 may indicate whether a command is to be retried (e.g., reissued) or if data requested by the command will be provided. For example, in one or more embodiments, the response phase may include a first stage 306, in which a read request may be transmitted from the requesting node 100 to the remote node 200. In stage 307, which may be performed simultaneously with stage 306, the coherency unit 122 may deliver an early bus data return indication which may provide a notification to the processor bus interface 120 to reserve capacity on the bus 110 for the return of the requested data, which may shorten arbitration on the bus 110 when the data is returned, for example.

Upon receipt of the command request from the requesting node 100, the remote node 200 may initiate collision detection and directory lookup procedures in order to locate the memory location (e.g., in local memory 214) from which data is to be accessed to process the request. The request may flow through pending request queues in the memory controller 212 of apparatus 200 and may be driven onto the memory interface 216. At this point, the number of cycles before data is to be returned from the local memory 214 may be readily determinable (e.g., based on DRAM timings tRCD, tCL). Determination of the number of cycles may allow an early indicator to be provided to the scalability port 220 that may indicate that the data response is coming in N cycles.

The scalability port 220 may, upon receiving the early indication of the data response, begin to construct a data response header and, in parallel, a header CRC. According to an embodiment of the present invention, the remote node 200 may construct a header CRC and send the header CRC along with the header in the first cycle of a response before all of the data has been retrieved.

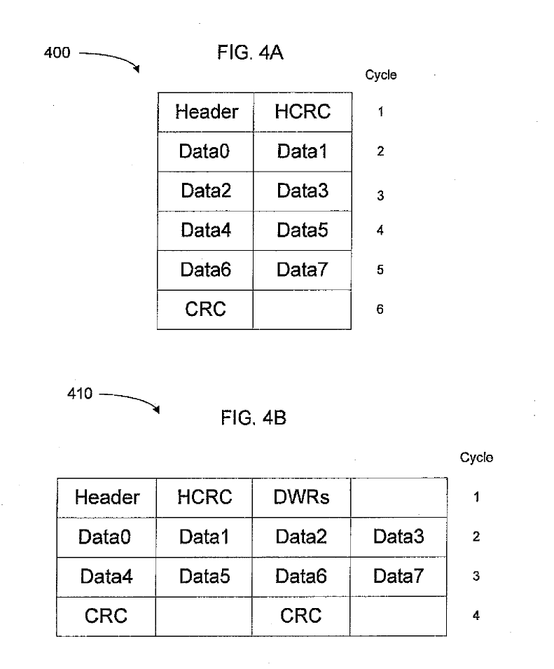

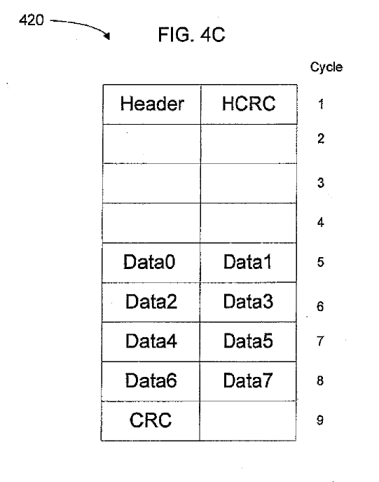

FIG. 4A is a schematic illustration an exemplary response packet according to the invention. The response packet 400 includes information that is sent sequentially in a number of cycles. As shown, in the first cycle (cycle 1) of the data response packet, both a header and a header CRC may be transmitted. The header may include information such as a transaction ID that matches corresponding information in the header included in the request received from the requesting node 100. In following cycles 2 through 5, segments of retrieved data Data0, Data1, Data2, Data3, Data4, Data5, Data6, Data7 may be transmitted. A CRC covering the entire packet 400 may be transmitted in cycle 6. It is noted that the size of the response packet 400 is exemplary, and that more or less data may be included in a given response packet depending on the amount of data required by the command request. FIG. 4B shows an analogous data response packet 410 that may be employed on a double-wide connection over SP links 218, 219. Similar to the data response packet of FIG. 4A, a header and header CRC may be transmitted in cycle 1. However, the data segments (Data0, Data1, Data2, Data3, Data4, Data5, Data6, Data7) may be transmitted in fewer cycles, e.g., two cycles (cycles 2 and 3) rather than in four cycles. As indicated, the data response packet of FIG. 4B may include two packet CRCs transmitted in cycle 4.

Referring again to FIG. 3, the requesting node 100 may receive the header and the header CRC in stage 310 and may validate the data response header in advance of a full data transfer and final CRC check over the entire data response packet. If the header CRC is valid, in stage 312, a deferred reply may be initiated on the bus 110 before all of the data is received in the data response from the remote node 200 over the SP link(s) 218, 219. In this manner, according to the invention, arbitration on the bus for the deferred reply can proceed several cycles in advance in comparison with conventional processing techniques. For example, referring to the exemplary packet of FIG. 4A, bus arbitration may begin after receipt and validation of the header CRC without the need to wait for data to be transmitted in cycles 2 through 6 (i.e., 5 cycles) or for a total packet CRC to be validated. According to this example, bus arbitration may occur at least five (5) cycles in advance.

In addition, the scalability port 220 on the remote node 200 may monitor link utilization to determine how soon to send the early data response header and header CRC. If the SP link(s) 218, 219 have spare capacity, the scalability port 220 may encode a number of empty cycles or ‘gap cycles’ between the header and data response as part of the data response header, thus expanding the total response packet to prevent fragmentation of the packet. FIG. 4C shows an exemplary packet 420 in which three gap cycles have been encoded between the header and the data response. However, if the SP link(s) 218, 219 are being heavily utilized and do not have spare capacity, gap cycles may not be encoded and construction of the response header may be delayed so as to line up with the data response from the local memory 214.

At the requesting node 100, once a header CRC has been validated, the header of the response packet, followed by any gap cycles, may be forwarded to the bus interface 120 to begin a deferred reply on the bus 110. The bus interface 120 may use the number of gap cycles and current bus utilization information to determine when to schedule the deferred reply. In one or more embodiments, the bus interface 120 may load a timer to track the time between the receipt of the early header and the completion of the response packet.

Stage 314 marks the receipt of the requested data within the response packet at the requesting node 100. In stage 316, the data may be returned to the processor 102 over the bus 110, having previously arbitrated for use of the bus 110 for this purpose after validation of the header CRC. In stages 318 and 319, the coherency unit 122 may update the directory and perform a cache write to create a copy of the data received. In stage 320, the entry for the command in the pending queue of the coherency unit 122 is retired.

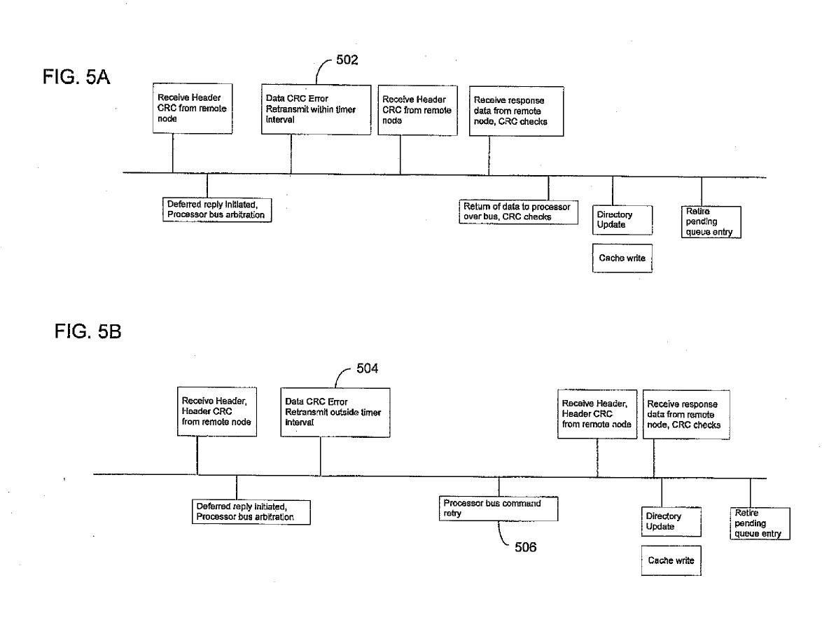

During processing of the command, there may be an error in the transmission of the data response, and the CRC performed on the received data may not check out. In this case, an embodiment of the present invention provides methods for error correction that allow the deferred reply to begin early despite the error. FIGS. 5A and 5B illustrate timing diagrams of alternative exemplary embodiments of command processing at the requesting node including steps for error correction/recovery. The timing diagrams of FIGS. 5A and 5B have a number of stages equivalent to those shown and described with reference to FIG. 3 and these equivalent stages are not numbered in FIGS. 5A and 5B.

FIG. 5A illustrates an example of command processing when the remote node 200 detects a single-bit-error (SBE) in data retrieved from local memory 214. When such an error is detected, the response packet may be ‘stomped’ whereby the data may be retrieved again from local memory 214. Despite the data error, the bus interface 120 at the requesting node 100 may still initiate the deferred reply if the header CRC is validated. In stage 502, the bus interface may load a timer. The snoop phase of the deferred reply may be delayed, and the timer may run until the full data response is received. If the response packet is retransmitted before the timer expires, and the data CRC is validated, the command request does not need to be retried, and the data may be returned to the issuing processor 102 as in the normal, error-free case.

In the process shown in FIG. 5B, a timer is loaded in stage 504. However, in this case the response packet may not be retransmitted correctly before the timer expires. In stage 506, the command may be retried back to the processor 102 while the remote node 200 may still be processing the original command request to avoid tying up the bus 110 for arbitration. The coherency unit 122 may then track processing of the command request until completion. The data may be returned to the requesting node before the processor reissues the command request. In this case, the returned data may be cached locally at the requesting node 100 and at the point at which the processor 102 reissues the command request, the data may be returned to the processor 102 from the local cache. In this manner, the processing of the command between the nodes 100, 200 over the SP link(s) 218, 219 via scalability port interfaces 125, 220 may continue even while transactions between the bus interface 120 and the issuing processor 102 are delayed.

The foregoing description discloses only exemplary embodiments of the invention. Modifications of the above disclosed apparatus and methods which fall within the scope of the invention will be readily apparent to those of ordinary skill in the art.

Accordingly, while the present invention has been disclosed in connection with exemplary embodiments thereof, it should be understood that other embodiments may fall within the spirit and scope of the invention, as defined by the following claims.

The invention claimed is:

1. A method of processing a command issued by a processor over a bus, comprising:
transmitting the command to a remote node to obtain access to data required to complete the command;
receiving from the remote node a response packet including a header and a header CRC;
validating the response packet including the header and the header CRC;
loading a timer to run until data required to complete the command is received or the timer expires; and
before receiving the data required to complete the command, arranging to return the data to the processor over the bus.

2. The method of claim 1, further comprising receiving the data required to complete the command before the timer expires.

3. The method of claim 1, further comprising receiving the data required to complete the command after the timer expires.

4. The method of claim 3, wherein the command to obtain access to the data required to complete the command is not retransmitted to the remote node.

5. The method of claim 1, further comprising tracking processing of the command issued by the processor.

6. The method of claim 1, further comprising receiving the data required to complete the command before the command issued by the processor is reissued by the processor.

7. The method of claim 6, further comprising:
storing the data required to complete the command in a local cache; and
returning the data stored in the local cache when the command issued by the processor is reissued by the processor.

8. A method of processing a command issued by a processor, comprising:
receiving the command from a requesting node over a communication link;
incorporating a header and a header CRC in a response packet;
transmitting the response packet including the header and header CRC before all of the data required to complete the command has been obtained;
determining than an error in the data required to complete the command has occurred; and
reobtaining the data required to complete the command.

9. The method of claim 8, wherein the determining that an error has occurred comprises determining that a single bit error has occurred.

10. An apparatus, comprising:
at least one processor;
a memory controller coupled to and adapted to receive commands from one of the at least one processor via a bus, and coupled to one or more remote nodes via a communication link;
wherein the memory controller is adapted to:
transmit a command issued by the at least one processor to a remote node over the communication link to obtain access to data required to complete the command;
receive from the remote node a response packet including a header and a header CRC;
validate the response packet including the header and the header CRC;
load a timer to run until data required to complete the command is received or the timer expires; and
before receiving the data required to complete the command, arrange to return the data to the processor over the bus.

11. The apparatus of claim 10, wherein the memory controller is adapted to receive the data required to complete the command before the timer expires.

12. The apparatus of claim 10, wherein the memory controller is adapted to receive the data required to complete the command after the timer expires.

13. The apparatus of claim 12, wherein the memory controller is adapted not to retransmit the command to obtain access to the data required to complete the command to the remote node.

14. The apparatus of claim 10, wherein the memory controller is adapted to track processing of the command issued by the processor.

15. The apparatus of claim 10, wherein the memory controller is adapted to receive the data required to complete the command before the command issued by the processor is reissued by the processor.

16. The apparatus of claim 15, wherein the memory controller is adapted to:
store the data required to complete the command in a local cache; and
return the data stored in the local cache when the command issued by the processor is reissued by the processor.

17. An apparatus, comprising:
an interface adapted to receive a command from one or more requesting nodes over a communication link;
memory including data required to complete the command; and
a memory controller coupled to the interface, the memory controller being adapted to construct a response packet including a header and a header CRC,
wherein the memory controller is adapted to
transmit the response packet including the header and header CRC before all of the data required to complete the command has been obtained;
determine than an error in the data required to complete the command has occurred; and
reobtain the data required to complete the command.

18. The apparatus of claim 17, wherein memory controller is adapted to determine that a single bit error has occurred.
